(19) United States
(12) Patent Application Publication
(10) Pub. No.: US 2007/0043648 A1
(43) Pub. Date: Feb. 22, 2007

(54) Foreign exchange trading platform

(76) Inventor: Jonathan Chait, Zug (CH)

Correspondence Address: MCDERMOTT, WILL & EMERY, 4370 LA JOLLA VILLAGE DRIVE, SUITE 700, SAN DIEGO, CA, 92122, US

(21) Appl. No.: 11/451,731

(22) Filed: Jun. 12, 2006

Related U.S. Application Data
(60) Provisional application No. 60/689,064, filed on Jun. 10, 2005.

(51) Int. Cl. G06Q 40/00

(52) U.S. Cl. 705/37; 705/39

(57) ABSTRACT

A foreign exchange platform for performing a foreign exchange transaction between a trading platform and a customer receives currency pair pricing information from a first liquidity provider and also receives the foreign exchange transaction from the customer. The platform then determines whether the foreign exchange transaction can be executed; and responsive to the determination, the foreign exchange transaction is placed on an internal order book. This is performed with the platform acting in an agency role in which the currency pair pricing information is presented unchanged to the customer.

### RELATED APPLICATIONS

The present application claims priority to U.S. Provisional Patent Application Ser. No. 60/689,064, filed Jun. 10, 2005, entitled “Foreign Exchange Trading Platform”, the disclosure of which is incorporated herein by reference in its entirety.

### TECHNICAL FIELD

This disclosure relates generally to the exchange and trading of currencies, and more particularly, to a trading platform for performing foreign exchange transactions (forex or FX) and managing forex exposures in other variable asset classes, such as foreign equities.

### BACKGROUND

Forex refers to a marketplace for exchanging various foreign currencies. In general terms, currencies are traded in pairs and exchanged one for the other when traded in the inter-dealer market. That is, forex trading is the simultaneous buying of one currency and selling of another. The rate at which these currencies are exchanged is referred to as the exchange rate and this rate fluctuates continuously depending on the market conditions.

Conventional forex trading environments are typically quote driven, paired currency contracts. Liquidity providers (such as banks and larger forex traders) provide real-time quotes for the various currency pairs (e.g., USD/EUR or USD/CHF or EUR/CHF). These quotes provide information about the exchange rate for buying and selling the currency pair as well as the quantities traded at the given quotes. In a typical forex trading environment, the platform offers its customers bid/ask prices that include some markup to generate revenue or profit for the platform or the broker-dealer who is operating this platform. For example, a liquidity provider, i.e., the inter-bank market, delivers a quote of “ask” at 15 while the trading platform will display to the Customer a 15.5 price. See FIG. 1A. Furthermore, a conventional platform is executing the forex trade as a counterparty in terms of the credit risk. One disadvantage of this technique is that customers may not be given the best available prices. Customers cannot easily evaluate whether the liquidity provider is offering the best available price in the market because the platform is marking up the prices that it receives from typically a single liquidity provider. Also, in the execution of the trades, the trading platform may be taking an adversarial position vis-a-vis the liquidity provider or the Customer while also charging the Customer a set commission at the same time.

Additionally, conventional forex trading platforms offer only a quote-style or quote-driven marketplace. For example, if the conventional forex platform is offering 10 bid at 15 ask, and if a Customer in response offers to sell at 12 for the bid at 10, the platform will reject the offer because it is dealing at 10 bid and 15 ask only. Even if other conventional platforms may accept orders between the posted quotes (i.e., between 10 bid and 15 ask), they nonetheless hide these transactions from the Customers. Continuing with the previous example, if a Customer places an order to sell at 12, i.e., a non-marketable order, a conventional platform may accept the order and only execute it when the platform's prices match the order (e.g., 12 bid at 17 ask). Assuming the fair value is the midpoint of the bid/ask spread, in this example the platform would treat a 12 bid at a point in time when the fair value is actually 14.5 (i.e., the midpoint between 12 bid and 17 ask). See FIG. 2. Thus, conventional platforms would not allow non-marketable quote execution. Again, in contrast, this platform would allow a Customer executing trade between the dealer quotes (10 bid and 15 ask) if another Customer would be willing to enter into a trade, e.g., at 12½ bid and ask. Thus, a Customer with the bid at 12½ would sell at a higher price than at the dealer bid of 10, and the Customer with the ask 12½ would buy at a better price than at the dealer ask quote of 15.

Thus, realizing these inefficiencies, what is needed is a forex trading platform that provides an exchange-style (as opposed to order-driven) order book that includes composite information about the best available price in the market. What is further needed is a forex trading platform that provides a broad set of tools for managing complex forex trades and for managing the exposure in post-trade assets as multicurrency cash balances. What is also need is a trading platform that acts as a pure agent by passing on the true quoted prices from liquidity providers without any markups.

### SUMMARY

One aspect of a trading platform relates to a method for performing a foreign exchange transaction between a trading platform and a customer. In accordance with this method currency pair pricing information is received at a trading platform from a first liquidity provider and the foreign exchange transaction from the customer is also received. The platform then determines whether the foreign exchange transaction can be executed; and responsive to the determination, the foreign exchange transaction is placed on an internal order book.

In certain aspects of the present disclosure, the trading platform implements one or more of the following features or functionalities individually or in combination:

a) Trading platform treats forex trades not as paired currency contracts, but rather as cash balances;

b) Interest is charged and paid overnight not on each currency pair, but rather on the aggregate balances;

c) Trading platform acts in an agency capacity and not of a riskless principal;

d) Trading platform does not charge markups or haircuts on quote;.

e) Trading platform allows its customers in forex to trade with each other thus providing additional liquidity;

f) Trading platform provides a wide slate of order types, and allows contingent orders and mixing asset classes;

g) Customer can trade out from a position on a cross-currency basis and not only per contract; and

h) Trading platform does not take adversarial position vis-a-vis banks or clients.

### BRIEF DESCRIPTION OF THE DRAWINGS

The accompanying drawings illustrate several embodiments and, together with the description, serve to explain the principles of the disclosure.

FIG. 1A is a diagram illustrating a prior art model of a forex trading platform according to the riskless principle model.

FIG. 1B is a diagram illustrating a model of a forex trading platform according to the agency model in accordance with an embodiment of the present disclosure.

FIG. 2 is a diagram illustrating execution of non-marketable quotes via internalizing order flow on the books of the trading platform according to an embodiment of the present disclosure.

FIG. 3 is a diagram further illustrating quote consolidation and general forex trading principles according to an embodiment of the present disclosure.

FIG. 4 is a diagram illustrating consolidating of the various dealer and liquidity provider quotes via smart routing processes and a data link according to an embodiment of the present disclosure.

FIG. 5 is a diagram illustrating execution of customer orders acting on liquidity providers' quotes via a trade link with dealers according to an embodiment of the present disclosure.

FIG. 6 is a diagram illustrating trade execution after best quotes were obtained.

FIG. 7 illustrates overall operation of trading platforms according to an embodiment of the present disclosure.

FIGS. 8-10 are screenshots illustrating an aggregate customer account showing various trades according to an embodiment of the present disclosure.

FIG. 11 is a table illustrating account management concepts and margining according to an embodiment of the present disclosure.

FIGS. 12-15 illustrate various examples of forex trading strategies according to embodiments of the present disclosure.

FIG. 16 illustrates a model of trading forex trades as separate currency deposits according to an embodiment of the present disclosure.

FIG. 17 is a diagram illustrating a computing device.

### CONCISE DESCRIPTION OF THE EMBODIMENTS

The following numbered statements set forth a concise description of the concepts presented herein:

### DETAILED DESCRIPTION OF THE EMBODIMENTS

The present disclosure is now described more fully with reference to the accompanying figures, in which several embodiments are shown. The present disclosure may be embodied in many different forms and should not be construed as limited to the embodiments set forth herein. Rather these embodiments are provided so that this disclosure will be thorough and complete and will fully convey the concepts to those skilled in the art.

A. System Overview

In certain embodiments of the present disclosure, a computer-implemented foreign exchange trading platform is provided. The trading platform receives a data stream from one or more liquidity providers. Each of the data streams includes a real-time representation of the bid/ask prices and quantities for the particular liquidity provider. The trading platform aggregates or consolidates the information to present the best available prices (a composite price or consolidated price) to its customers. Customer orders can be routed to the liquidity providers for execution or executed within the trading platform itself. This enables customers to perform forex trades with other customers for orders that are non-marketable.

The non-marketable customer orders are managed on an internal order book. The bid/ask prices on the internal order book are also included in the composite price information available to customers. By transparently offering its customers the same prices provided by the liquidity providers (and/or from the internal order book), the trading platform advantageously functions as a pure agent in the transaction. In this configuration, the trading platform charges a predefined commission for the transaction, rather than modifying the price quotes received from the liquidity providers or generating revenue on bid/ask spreads. Another advantage of this arrangement is that the trading platform avoids taking an adversarial position vis-a-vis the liquidity providers or the customers.

Another aspect of the trading platform is the post-trade treatment and management of asset exposures. A multicurrency account management system and interface enable customers to perform multicurrency transactions without opening multiple bank accounts around the world. From the customer's perspective, performing forex trade is seamless because a customer can deposit a single currency in an account and trade a product denominated in another currency. A margin loan may be created which is secured by the customer's deposited base currency. The customer may adjust foreign currency risks or eliminate the margin loan at any time by trading currencies. Certain aspects of account management, such as margining, which may be implemented in conjunction with embodiments of the present disclosure are described in additional detail in the U.S. Patent Application of Thomas P. Peterffy et al., Ser. No. 10/465,827, filed Jun. 20, 2003, entitled “System for Managing Multiple Types of Accounts having Different Regulatory Requirements,” the pertinent disclosure of which is incorporated by reference herein.

B. Trading Platform

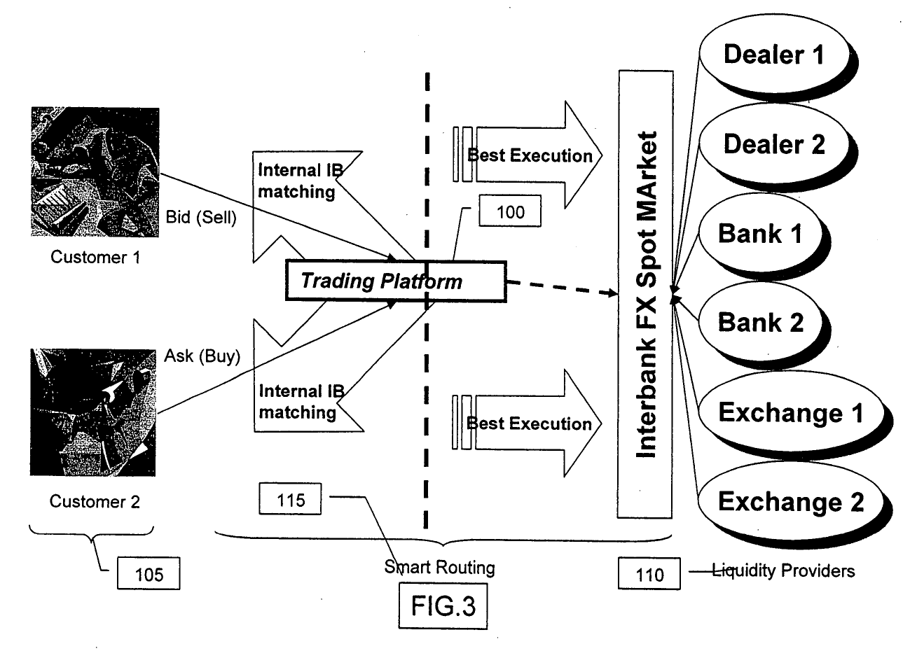

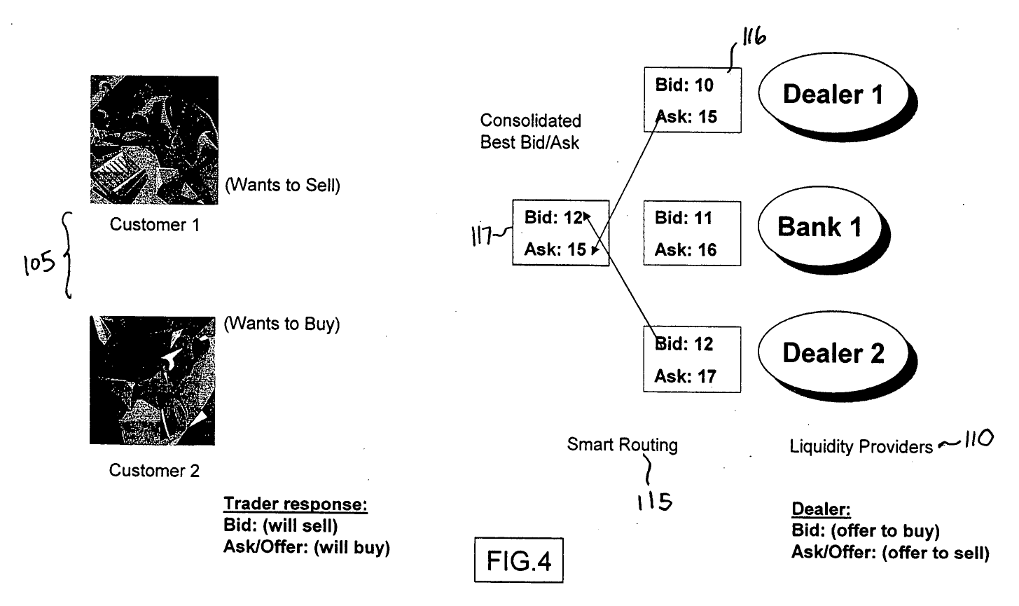

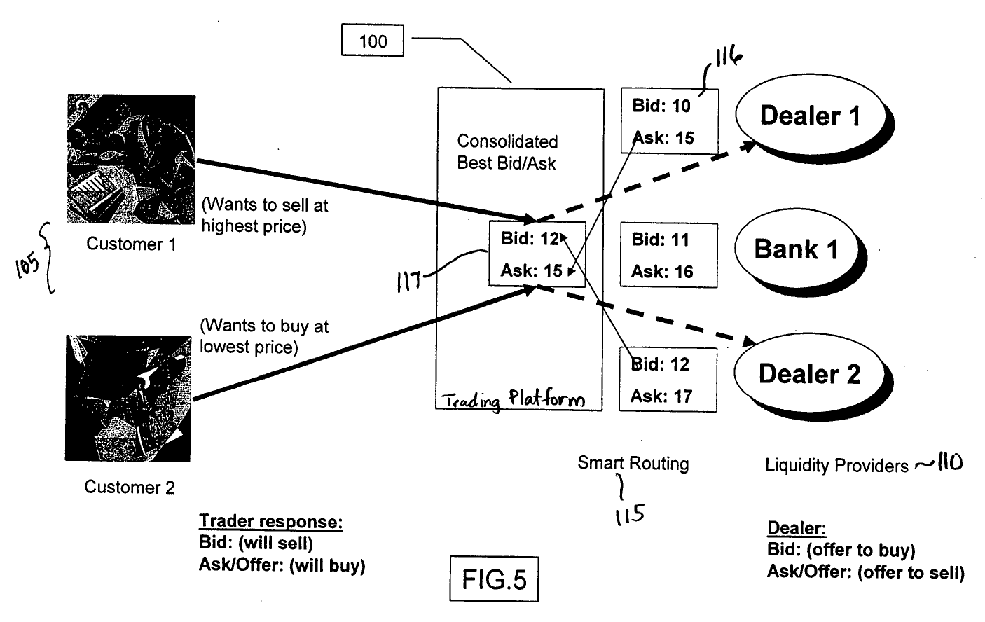

FIG. 3 is a diagram illustrating a foreign exchange (forex) trading platform according to an embodiment of the present disclosure. The illustrated embodiment includes a trading platform 100, a plurality of Customers 105, and a plurality of liquidity providers 1 10. The trading platform 100 establishes connectivity to the plurality of liquidity providers 1 10 using conventional data exchange techniques. In the illustrated embodiment, the liquidity providers 110 are third-party foreign exchange dealers, banks, and exchanges. The liquidity providers 110 (e.g., bank 1) provide a data channel for submitting quotes (the data channel) and submitting orders and receiving trade confirmations (i.e., a trading channel). The data channel includes current real-time quotes for the various currency pairs. The trading platform 100 receives the real-time quotes and consolidates them into a best of market view that is advantageously presented to the Customer 105 in an exchange-style order book. Further details of the data consolidation are provided below with reference to FIGS. 4-5.

The trading platform 100 also incorporates smart routing logic 115. Smart routing refers to the ability of the trading platform 100 to obtain best execution for the Customer by electronically routing the orders to one or more of the liquidity providers 110 component parts of the orders may be split among one or more of the liquidity providers 110 and/or executed from the internally managed order book to achieve the best possible execution.

1. Quote Consolidation and Smart Routing

FIGS. 4-5 are diagrams illustrating quote consolidation and smart routing according to an embodiment of the present disclosure. To further describe how quotes from the plurality of liquidity providers 110 are consolidated, FIG. 5 includes an example having three liquidity providers. Each of the liquidity providers provides a real-time quote 116 to the trading platform 100 for a particular currency pair (e.g., USD/EUR). As one skilled in the art will appreciate, the illustrated example includes hypothetical numbers to demonstrate the concepts of the disclosure. Customer 1 wants to sell. Customer 2 wants to buy. Dealer 1 provides a bid of 10 and an ask of 15. Dealer 2 provides a bid of 12 and an ask of 17. Bank I provides a bid of 11 and an ask of 16. The trading platform 100 evaluates each of these quotes and provides a consolidated or composite quote 117 of bid at 12 and ask at 15 (which is the lowest available price to buy currency and the highest available price to sell the currency). In one implementation, the consolidated quote 117 is visually presented for the Customer in an exchange-style order book. The consolidated quote represents the best available prices from the set provided by the liquidity providers, and, unlike other trading platforms is a composite quote from the multiple liquidity providers.

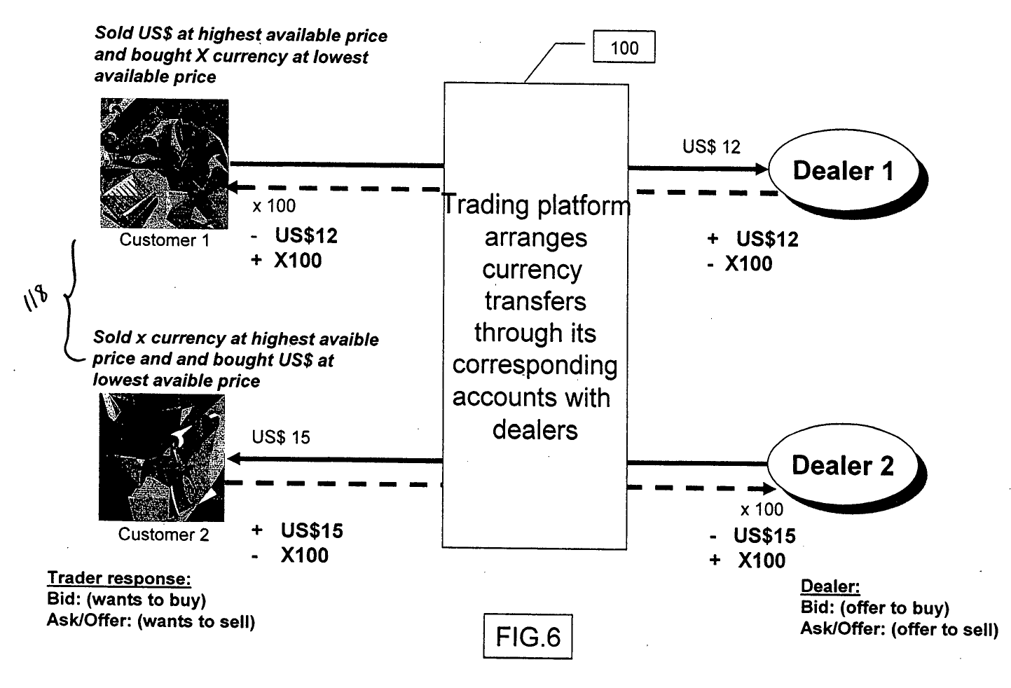

FIG. 6 illustrates an example of the smart routing technique and trade execution. As will be appreciated by persons skilled in the art, the plurality of liquidity providers are abstracted from the Customer's point of view. The Customer receives best of market prices, and the trading platform determines how to route the order for execution. If Customer 2 places an order to buy at 15, then his order is executed with Dealer 2. If Customer 1 places an order to sell at 12, then his order is executed with Dealer 1.

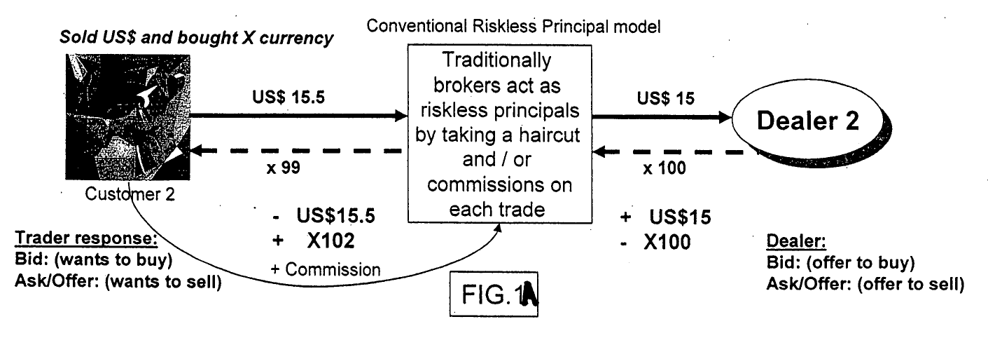

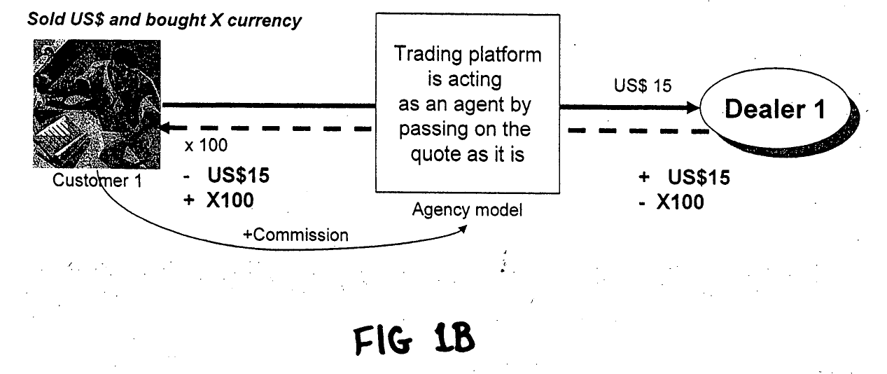

The embodiment illustrated in FIG. 6 shows the banking actions associated with executing a forex trade. The trading platform 100 arranges the currency transfers on behalf of its Customers 118. Further details on the relationship of the Customer with the trading platform 100 are described below and also shown in FIG. 1B.

2. Non-Marketable Orders

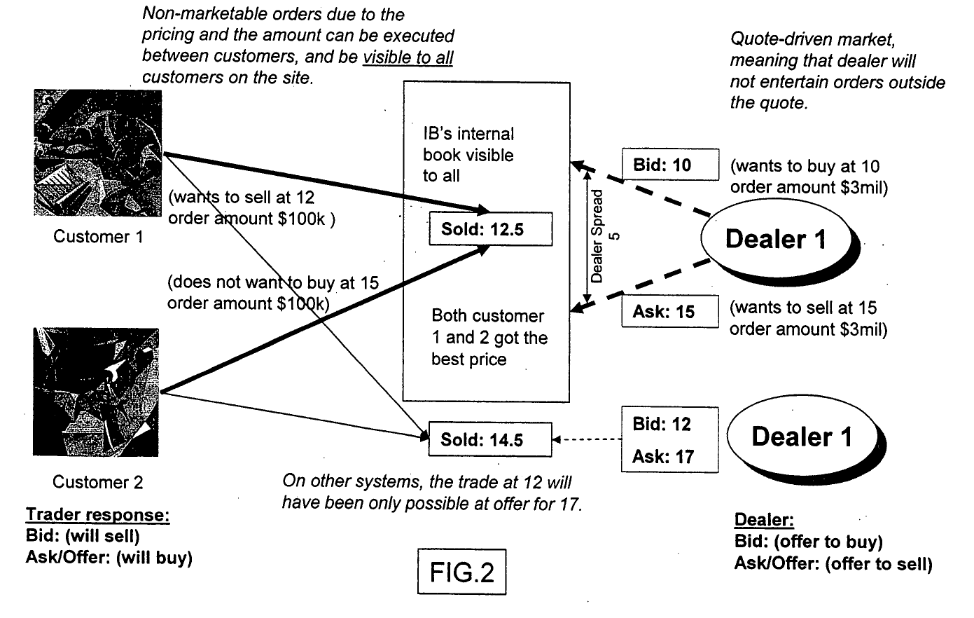

Non-marketable customer orders are managed on an internal order book. The bid/ask prices on the internal order book are also included in the composite price information available to Customers. FIG. 2 illustrates an example of a customer-to-customer forex trade. Dealer 1 (who is quote driven) has bid at 10 and ask at 15 (with a spread of 5). Customer 1 wants to sell at 12, which is greater than Dealer 1's bid price. The trading platform internally books this order because it cannot be executed with Dealer 1. Customer 2, however, does not want to buy at 15, which is Dealer l's ask price. Because the currency pairs that are internally booked are also included in the composite price information, Customer 2 has visibility of the better deal from Customer 1 (in certain implementations, the Customer quote is evident to other customers because it will be for an amount that would be lower than normally offered by a dealer). The trading platform matches the transactions, and both Customers 1 and 2 get the best price at 12.5 (which is a mid-point between Dealer's quotes).

3. Agency Role

By transparently offering its customers the same prices provided by the liquidity providers (and/or from the internal order book), the trading platform advantageously functions as a pure agent in the transaction even though it legally functions as a riskless principal by being the only single credit counterparty to both the dealers and the customers. FIGS. 1A and 1B contrast the agency approach with the conventional riskless principal model. According to the concepts of the present disclosure, the trading platform charges a predefined commission for the transaction, rather than modifying the price quotes received from the liquidity providers or generating revenue on bid/ask spreads. Another advantage of this arrangement is that the trading platform avoids taking an adversarial position vis-a-vis the liquidity providers or the customers.

4. Transaction Process

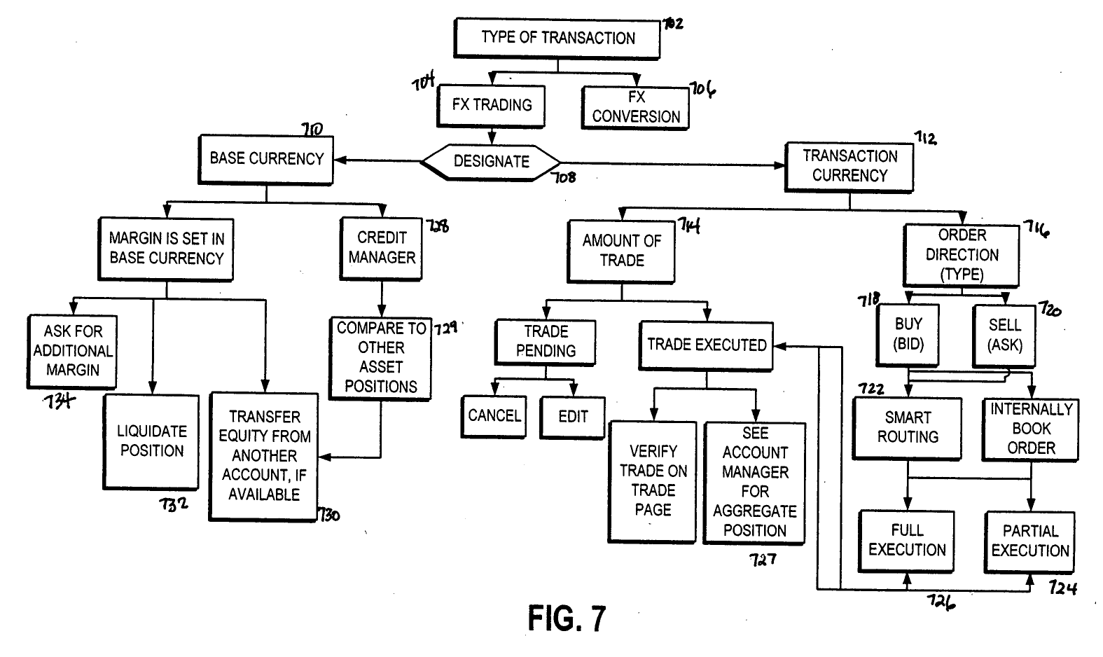

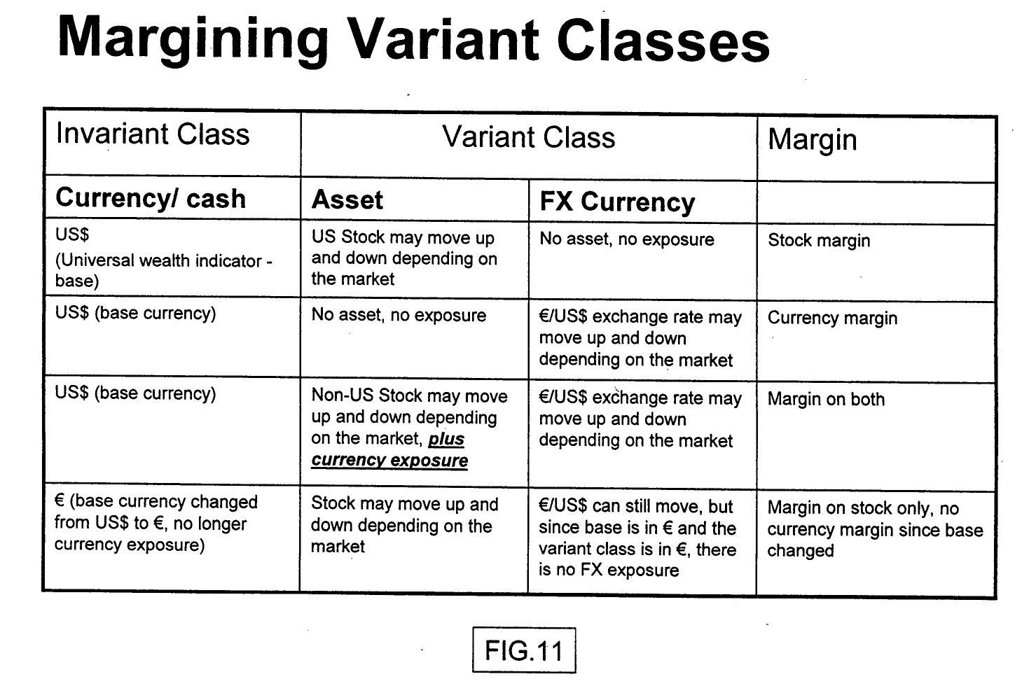

FIG. 7 illustrates the steps that are taken when a typical currency trade transaction 702 is executed in one implementation of the disclosed concepts. First, a Customer decides whether he or she will utilize the currency trading 704 or the currency conversion 706 facility on the trading platform. If the Customer chose the trading facility, the Customer will need to designate 708 the base currency 710, i.e., the currency in which the Customer's universal wealth will be determined and against which all other assets will be benchmarked. For example, if the base currency 710 is selected in US dollars, this means that all trades and all assets purchased or sold on the trading platform will be measured in their present value vis-a-vis US dollars. In other words, the base currency is an invariant asset class, and all other assets are variant and may fluctuate in value depending on the direction of the market, as with for example stocks or bonds, or the direction of the currency exchange rates, as would be the case with currency trading. See FIG. 11 illustrating characteristics of variant and invariant classes. After making an initial deposit of liquidity in the designated base currency, the Customer can start trading. As illustrated in FIG. 11, there are two inherent risks with trading non-US assets: assets risk (e.g., movement in stock prices) and currency exposure (e.g., movement US$/ε rate) These are variant asset categories and margin is calculated with respect to variant asset categories.

Returning now to FIG. 7, after transaction (or underlying) currency712 has been designated, Customer specifies the amount of the proposed trade 714 and the type of the order 716, such as a buy order 718 or a sell order 720. As explained above, the trading screen where the orders are placed provides the aggregate best quote generated via smart routing 722 mechanism on the trading platform. In certain embodiments, these aggregate bid and ask quotes are continuously updated and the Customer will have a real-time view of the market and where his or her quote is as compared to the market. Until the posted Customer's quote is accepted and transmitted, the quote can be cancelled and or modified. After the order has been executed, the order cannot be modified and instead will be displayed on the order log screen. The order may be executed partially 724 or fully 726.

In addition to specifying whether it is a buy or a sell order, the Customer will also designate what kind of an order this would be. The trading platform offers a wide slate of various kinds of orders, such as market order, limit order, and other various kinds of combination orders.

After the forex trade is executed, the Customer can verify its total position on the universal account page 727 where the Customer's aggregate position in all currencies and in all asset classes is presented. Thus, the Customer can have a real-time snapshot of his or her liquidity, asset and currency positions at any time. Moreover, these positions are continuously updated depending on the movement in the market.

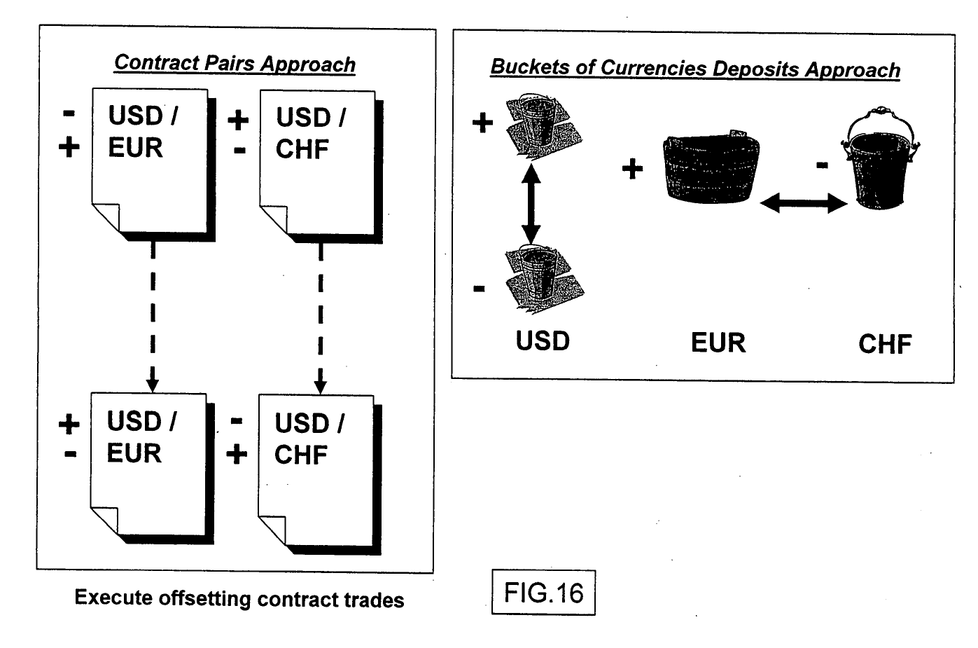

In addition to the aggregating the Customer's position, the trading platform also utilizes the credit manager function 728 which determines whether the platform must charge certain margin with respect to Customer's positions. Margin is charged on non-base-currency exposure, such as forex trades. In addition, depending on the country of the regulator relevant for a given asset class, a margin may be charged on the securities positions as well. In the event that the Customer does not have enough liquidity in the account 729, the credit manager will withdraw 730 the excess liquidity with respect to other variant asset classes, request additional margin 734,or will liquidate the position 732 to maintain the adequate margin protection. Because the trading platform does not treat currency trades as separate and discrete currency contracts, see FIG. 16, and instead treats these forex positions as cash deposits or cash loans (depending on whether this is a long or a short position), credit manager may transfer excess equity from different sub-accounts.

Finally, in certain implementations, the Customer is charged the applicable interest rate on its short positions in forex and will be paid applicable interest on its long positions. Because the trading platform does not treat currency trades as separate currency pairs, Customers gain by not being charged duplicative rates on separate positions while it is possible to charge only a single rate on the aggregate position assuming that some of the positions may offset each other and limit the aggregate exposure. The following sections provide illustrative examples of how various trades are executed and are booked on the trading platform.

5. Account Management

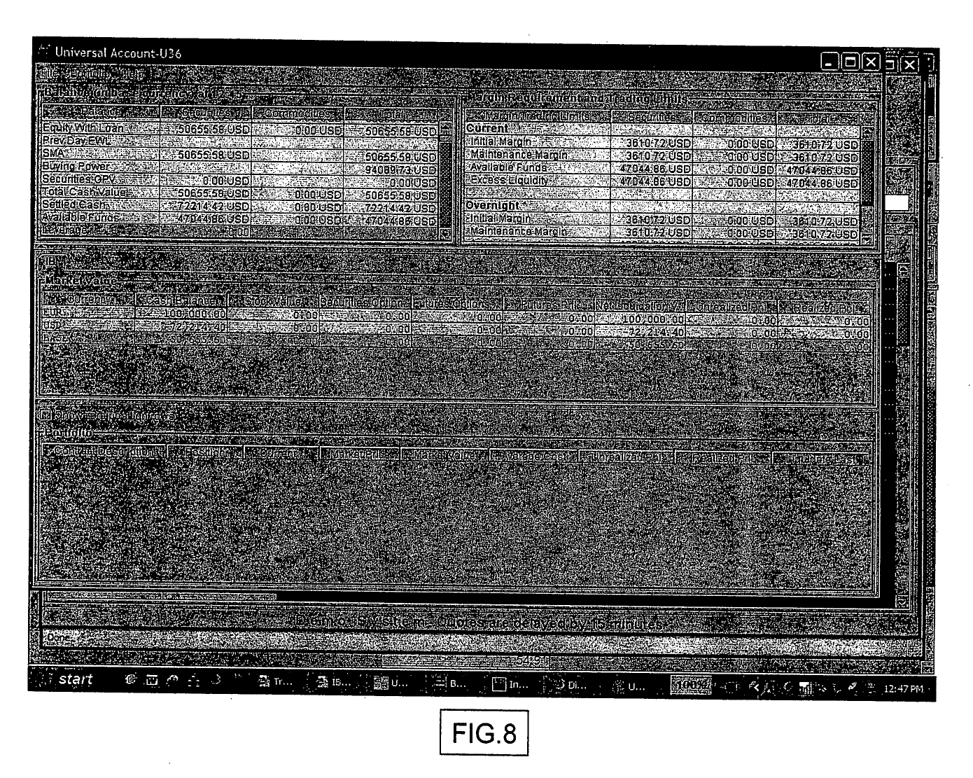

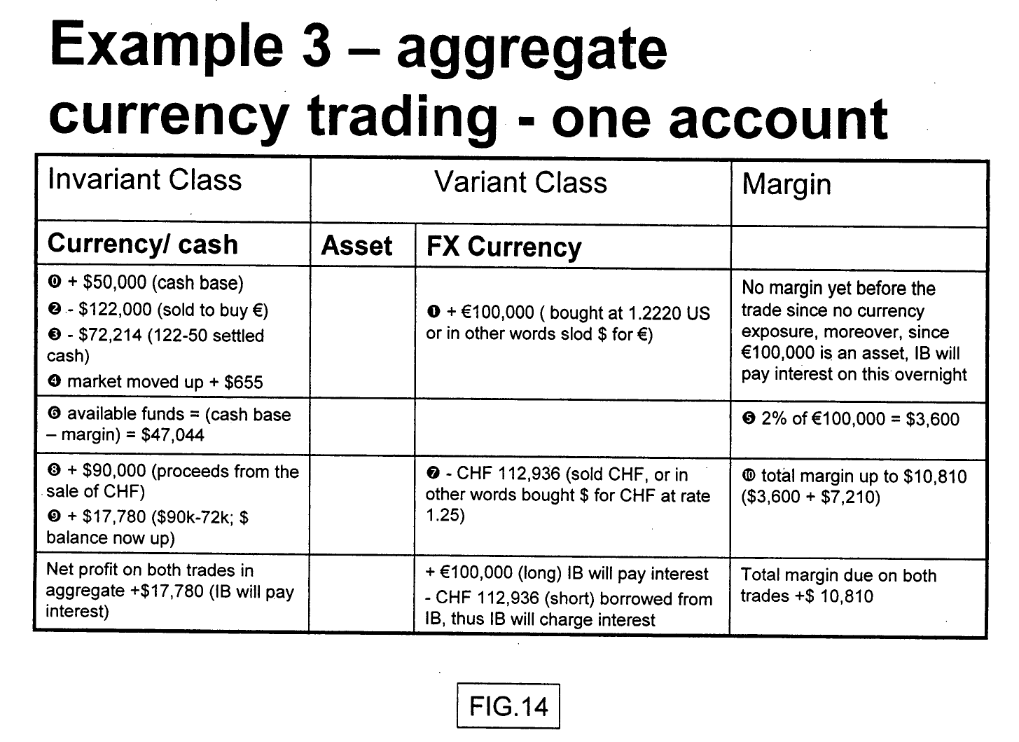

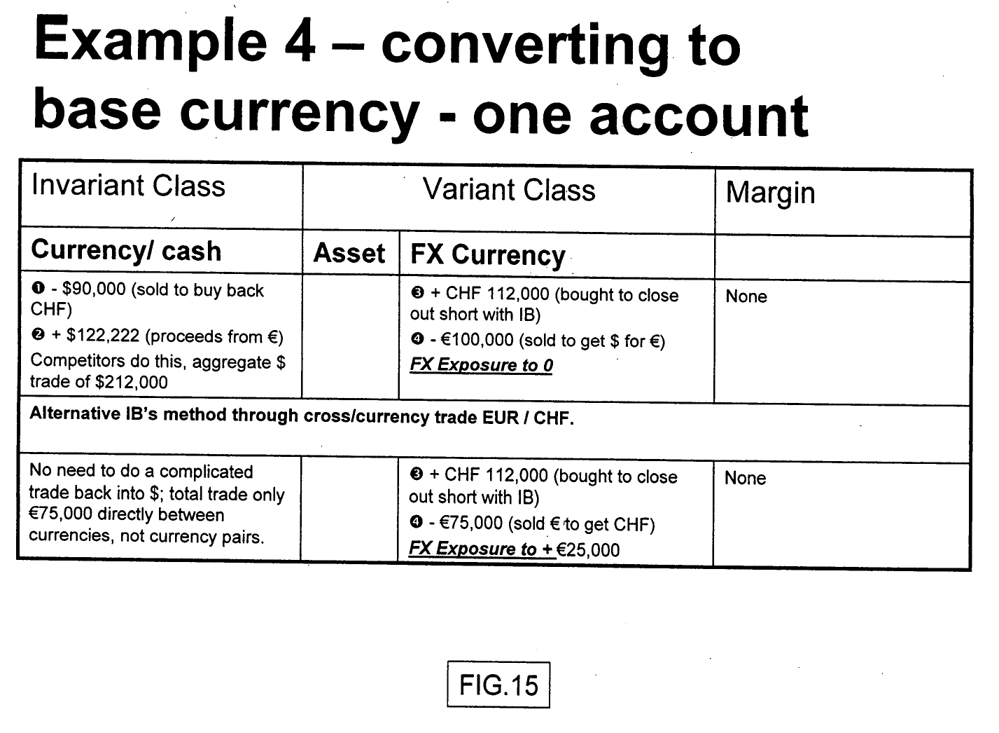

FIGS. 8-10 are screenshots illustrating a customer account management interface according to an embodiment of the present disclosure. FIGS. 8-10 show the market value of forex positions according to the following exemplary trading activity. The market value includes an expression of wealth in a customer selectable base currency (BASE in the figures). More specifically, the base currency reflects the customer's definition of wealth measurement (e.g., U.S. dollars). As discussed above, the trading platform (via the account management system) margins all the assets whose currency denomination is different from the base currency. Note, screenshots FIG. 8-10 relate to the examples presented in FIG. 14 and FIG. 15.

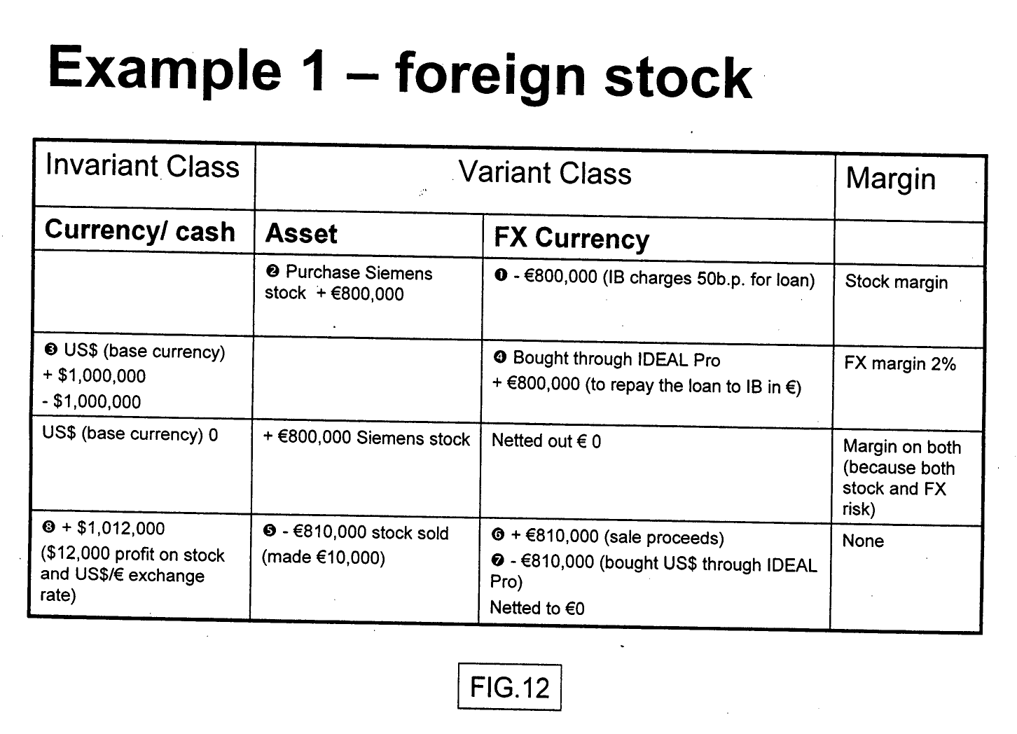

FIG. 12 illustrates the following account management example: Suppose the Customer deposits USD 1 million and then converts the USD 1 million in a currency trade to EUR 800,000 (step 1). Because the Customer's wealth is presently measured in USD, the Customer would have currency risk. Because of this risk, the trading platform enforces a margin requirement (e.g., 2%). Note, base currency can be changed at any time. In this example, if the base currency changed to EUR, there would be no currency exposure and no margin will be due.

One advantage of the present disclosure is that the trading platform seamlessly allows the customer to decide how much currency exposure he wants to have in his overall investment profile, regardless of the asset class. For example, a Customer has USD 1 million and buys USD 1 million worth of Siemens stock (step 2) FIG. 12 without doing any currency transactions. In this case, because Siemens is a Euro-denominated instrument the market value will show an asset of plus EUR 800,000 Siemen stock and a liability of minus EUR 800,000 in EUR cash (which essentially is a loan from the trading platform to the Customer). The base currency value will still reflect approximately USD 1 million in assets (step 3). The net EUR exposure is zero and therefore there is no currency margin. The only risk is due to the change in the market value of Siemens.

At the point that Siemens stock does move, the Euro balance becomes non-zero, whether it is a gain or a loss, then there is some currency exposure in addition to the exposure of the change in current stock market in general and Siemens stock in particular. The Customer can decide that he does not want to be borrowing Euros from the trading platform (e.g., at 50 basis points). The Customer can decide to create currency risk and reduce interest rate exposure by buying EUR 800,000 by selling the USD 1 million (step 4). The new portfolio looks like zero USD, zero EUR and USD 800,000 worth of Siemens stock. In base currency terms, the Customer's wealth is still USD 1 million, because the net asset in EUR is converted back to the base currency units. The risk is now relative to the Customer's base currency, so the trading platform imposes a margin requirement (e.g., 2%) on top of whatever margin is required for holding the Siemens stock.

As one skilled in the art will appreciate, the present disclosure advantageously provides the Customer with the ability to manage an entire portfolio and the associated currency risks. The Customer can minimize currency risk if desired, trade foreign cash as an asset, or trade cash as a risk management tool.

Returning to FIGS. 8-10, the trading platform considers the positions after a forex trade as cash buckets (see FIG. 16). Conventionally, forex providers treat currency pairs as separate and discrete currency pair contracts, which imposes limitations on how positions can be unwound. In the conventional sense, if a Customer trades into USD/EUR, he must trade out of USD/EUR. One advantage of the present disclosure is that the account management treats the positions similar to bank balances in the respective currencies. Thus, in the previous example, the Customer has EUR balances and USD balances and can convert the money into any other form of money in the most efficient, customer-selected manner. See FIG. 15 for an illustration of closing out and/or limiting currency exposures.

More specifically, FIG. 8 illustrates market value after a particular USD/EUR trade. Starting with base currency of USD 50,000, the Customer executed a USD/EUR transaction for EUR 100,000. The base currency (or universal wealth) is not effected by doing a transaction, except to the extent that market moved slightly in the Customer's favor after the trade (see additional USD 655.60 added to he base currency). The account management interface also shows the margin requirement and the available funds (i.e., base currency value-margin requirement). See FIG. 14, steps 0-6.

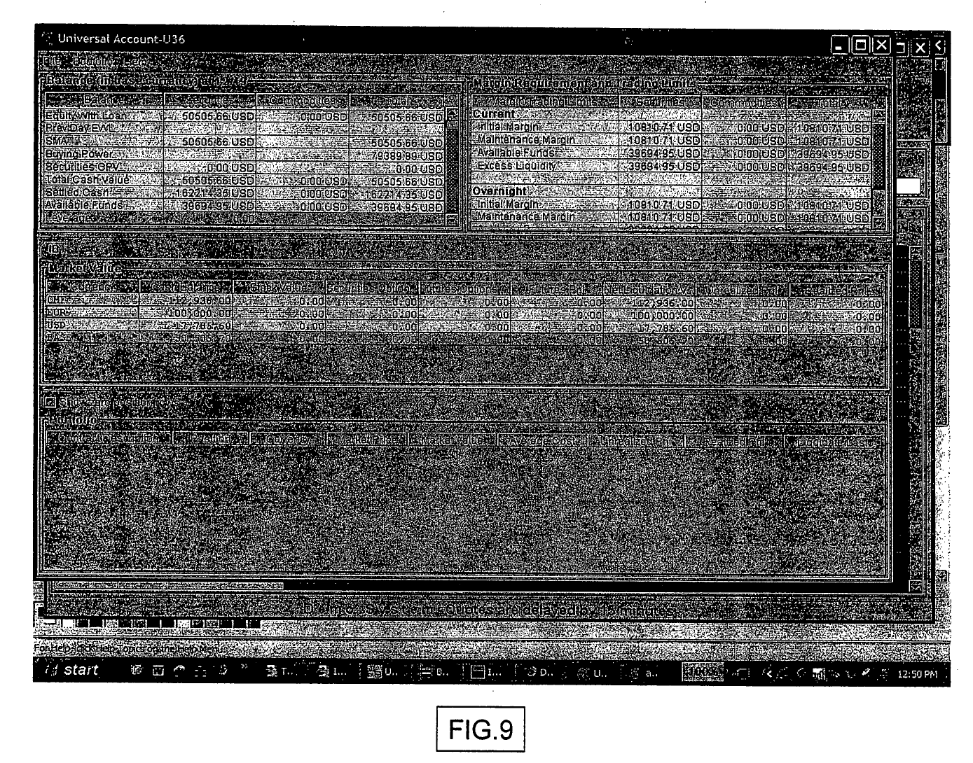

FIG. 9 illustrates the state of the account management interface after another trade—selling CHF and buying USD in approximately the amount of USD 90,000. In this case, the EUR balance is unchanged because this transaction did not effect EUR. The CHF bank balance is short CHF 112,000 which is approximately equal to USD 90,000 times a rate of 1.25. As one skilled in the art will appreciate, the customer's overnight interest cost (i.e., financing cost) is based on the net of those two trades. Specifically, the trading platform will charge the Customer for borrowing CHF 112,000 and credit the Customer for the EUR 100,000 and the USD 18,000.

By way of contrast, a conventional forex trading platform will credit interest on the long EUR (100,000 of them) and charge interest on the short USD (122,000 of them). In this case, the conventional forex platform would charge the customer 0.5% on approximately USD 200,000 (i.e., USD 122,000 plus USD 72,214), rather than 0.5% on USD 18,000 (the aggregate of all Customer's USD positions) according to the present disclosure.

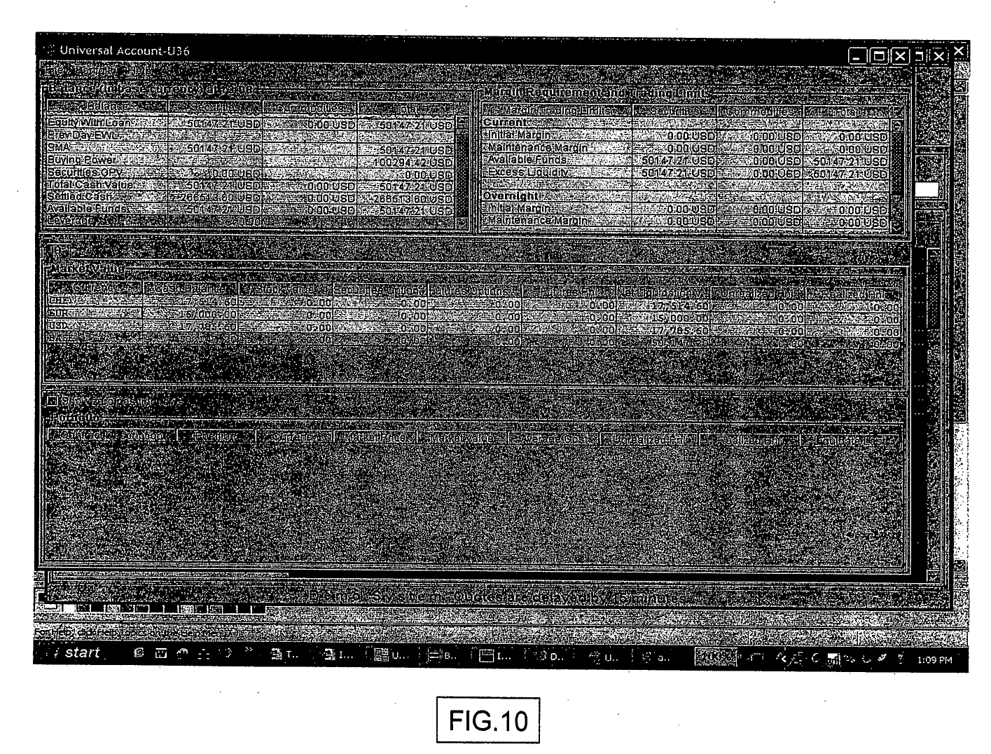

FIG. 10 and FIG. 15 illustrate the state of the account management interface after a third trade-selling EUR and buying CHF is executed. This transaction illustrates that in an implementation of the present disclosure, forex positions may be unwound without unwinding the same currency pairs (i.e., USD/EUR and USD/CHF), but rather by putting on a cross-trade between two foreign currencies at a significant savings in transaction costs to the Customer. Recall that in this example, the Customer obtained a EUR position via a USD/EUR transaction.

6. Complex Trades and Contingent Orders

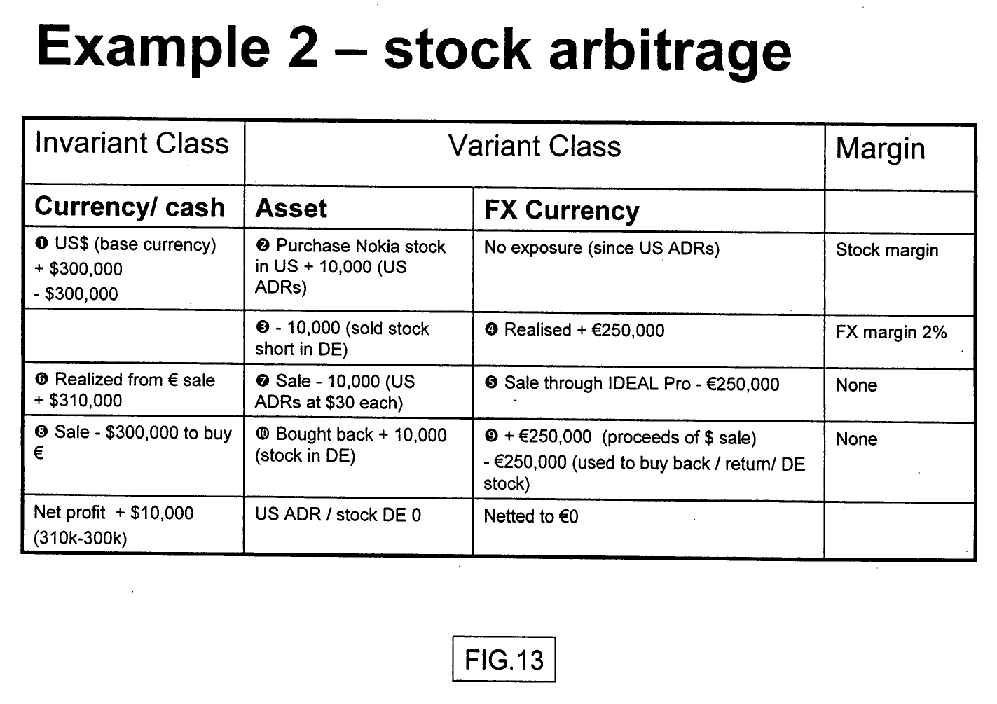

The trading platform offers a very rich set of order types which are not generally available on typical foreign currency platforms. The full range of order types allows execution of various complex combination trades. For example, FIG. 13 illustrates how a stock arbitrage transactions can be executed on two markets—in the US and in Germany. Assume a Customer buys Nokia stock in the US which stock is traded in the form of ADRs (American Depository Receipts) on a stock exchange. Because the Customer's base currency is USD and because the Nokia ADRs are denominated in USD, there is no currency risk. Further, assume that the Customer suspects that there is a price differential between the trading of Nokia stock in the form of ADRs in the US and Nokia stock in Germany, which is also a liquid market in Nokia stock.

Next, the Customer sells short Nokia stock in Germany and realizes a certain amount in EUR. At this point, there is currency exposure because the stock has been converted into EUR and the base currency is in USD. Because Nokia stock (the underlying asset) is the same in the US and Germany, the main risk would be currency risk when the Customer will have to liquidate the short sale of Nokia stock in Germany.

Realizing that stock arbitrage has currency risks, Customers can execute these Nokia trades with placing linked conditional orders, such as requesting the purchase of the Nokia stock in Germany and a linked order in EUR to flatten the Customer's currency exposure. As the steps 5 through 10 illustrate in FIG. 13, through the currency trades the Customer in that example was able to realize the net profit of USD 10,000.

Because the trading platform is a multi-asset platform, it can let customers enter various sophisticated order types-variant of the advance order type methods. For instance, the platform would allow a customer to link an order to buy British pounds when the relationship between USD and EUR crosses a certain point. Because a customer might believe he has a British pound exposure which may be impacted at the point when the European-American overall relationship looks a certain way.

C. Computing Device

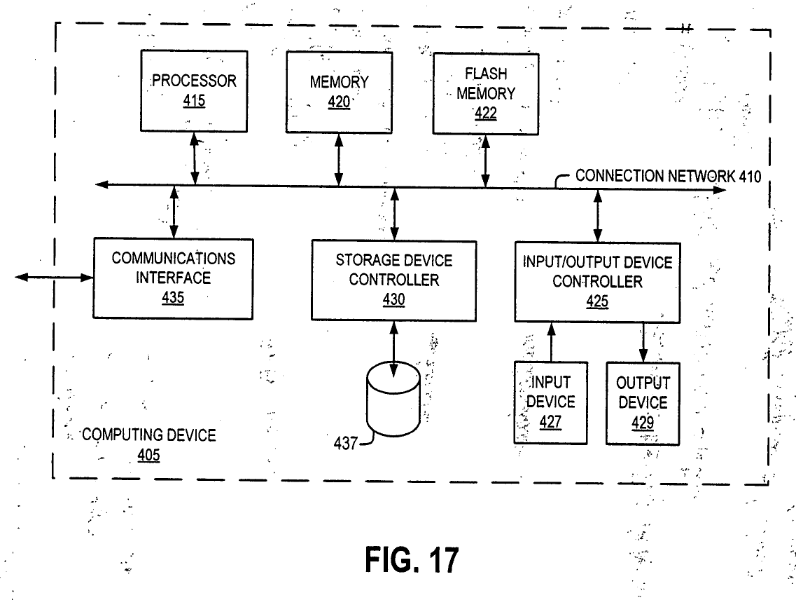

FIG. 17 is a diagram illustrating a computing device. A computing device is generally an efficient way of implementing the features or functions disclosed herein. In the examples described above, a computing device is used to implement the features of the trading platform 100, such as electronic order submission and execution.

In the illustrated embodiment, the computing device 405 includes a connection network 410, a processor 415, a memory 420, a flash memory 422, an input/output device controller 425, an input device 427, an output device 429, a storage device controller 430, and a communications interface 435. Also included is an internal storage device 437.

The connection network 410 operatively couples each of the processor 415, the memory 420, the flash memory 422, the input/output device controller 425, the storage device controller 430, and the communications interface 435. The connection network 410 can be an electrical bus, switch fabric, or other suitable interconnection system.

The processor 415 is a conventional microprocessor. The processor 415 executes instructions or program code modules from the memory 420 or the flash memory 422. The operation of the computing device 405 is programmable and configured by the program code modules. Such instructions may be read into memory 420 or the flash memory 422 from a computer readable medium, such as a device coupled to the storage device controller 430.

Execution of the sequences of instructions contained in the memory 420 or the flash memory 422 cause the processor 415 to perform the method or functions described herein. Although a single computing device is shown, one skilled in the art will appreciate that the functionality described herein may be implemented using a component software architecture (e.g., Java 2 Enterprise Edition) and distributed among a plurality of computing devices. In alternative embodiments, hardwired circuitry may be used in place of or in combination with software instructions to implement aspects of the disclosure. Thus, embodiments of the disclosure are not limited to any specific combination of hardware circuitry and software. The memory 420 can be, for example, one or more conventional random access memory (RAM) devices. The flash memory 422 can be one or more conventional flash RAM, or electronically erasable programmable read only memory (EEPROM) devices. The memory 420 may also be used for storing temporary variables or other intermediate information during execution of instructions by processor 415.

The input/output device controller 425 provides an interface to the input device 427 and the output device 429. The output device 429 can be, for example, a conventional display screen. The display screen can include associated hardware, software, or other devices that are needed to generate a screen display. The illustrated embodiment also includes an input device 427 operatively coupled to the input/output device controller 425. The input device 427 can be, for example, an external or integrated keyboard or cursor control pad.

The storage device controller 430 can be used to interface the processor 415 to various memory or storage devices. In the illustrated embodiment, the internal storage device 437 is shown for storing software applications (e.g., an account management interface), user data, system configuration, and the like. As one skilled in the art will appreciate, the internal storage device 437 can be any suitable storage medium, such as magnetic, optical, or electrical storage.

The communications interface 435 provides bidirectional data communication coupling for the computing device 405. The communications interface 435 can be functionally coupled to a local area or wide area network. In one embodiment, the communications interface 435 provides one or more input/output ports for receiving electrical, radio frequency, or optical signals and converts signals received on the port(s) to a format suitable for transmission on the connection network 410. The communications interface 435 can include a radio frequency modem and other logic associated with sending and receiving wireless or wireline communications. For example, the communications interface 435 can provide an Ethernet interface, Bluetooth, and/or 802.11 wireless capability for the computing device 405.

Having described embodiments of foreign exchange trading platform (which are intended to be illustrative and not limiting), it is noted that modifications and variations can be made by persons skilled in the art in light of the above teachings. It is therefore to be understood that changes may be made in the particular embodiments or implementations disclosed.

What is claimed:

1. A method for performing a foreign exchange transaction between a trading platform and a customer, the method comprising:
receiving, by the trading platform, currency pair pricing information from a first liquidity provider;
receiving the foreign exchange transaction from the customer;
determining whether the foreign exchange transaction can be executed; and
responsive to the determining, placing the foreign exchange transaction on an internal order book.

2. The method of claim 1, further comprising:
receiving, by the trading platform, currency pair pricing information from a second liquidity provider; and
generating a composite price for the currency pair based on the pricing information received from the first and the second liquidity providers.

3. The method of claim 2, wherein generating a composite price for the currency pair further comprises:
evaluating the currency pair pricing information received from the first and second liquidity providers to identify a best seller and a best buyer from a perspective of the customer; and
routing the foreign exchange transaction to at least one of the best seller and the best buyer.

4. The method of claim 3, further comprising:
repeating the receiving of currency pair price information for a plurality of liquidity providers; and
repeating the generating of a composite price for the currency pair based on the pricing information received from the plurality of liquidity providers.

5. The method of claim 1, wherein the currency pair pricing information includes a plurality of currency pairs.

6. The method of claim 1, wherein the currency pair pricing information includes a bid price and the step of determining is performed using the bid price.

7. The method of claim 6, wherein the trading platform charges the customer a commission based on an amount of the foreign exchange transaction.

8. The method of claim 1, wherein the currency pair pricing information includes an ask price and the step of determining is performed using the ask price.

9. The method of claim 8, wherein the trading platform charges the customer a commission based on an amount of the foreign exchange transaction.

10. The method of claim 1, further comprising the step of:
receiving, by the trading platform, at least one of a bid price and ask price from another customer related to the currency pair;
generating a composite price for the currency pair based on the pricing information received from the first liquidity provider and the at least one bid price and ask price from the another customer.

11. The method of claim 1, further comprising the steps of:
receiving from the customer a transaction request for an asset other than a foreign exchange transaction; and
performing the transaction request.

12. The method of claim 11, wherein the transaction request relates to buying or selling one or more equity instruments.

13. The method of claim 12, further comprising the step of:
managing an account for the customer such that the one or more equity instruments are valued according to a base currency selected by the customer.

14. The method of claim 13, wherein all assets within the account are valued according to the base currency.

15. The method of claim 14, wherein the base currency is changeable by the customer without liquidating an assets within the account.

16. A system for performing a foreign exchange transaction for a customer, the system comprising:
a trading platform configured to receive currency pair pricing information from a first liquidity provider and to receive the foreign exchange transaction from the customer;
a quote matching component configured to determine whether the foreign exchange transaction can be executed; and
an internal order book, responsive to the quote matching system, in which the foreign exchange transaction is placed.

17. The system of claim 16, wherein the trading platform is further configured to receive currency pair pricing information from a second liquidity provider; and the system further comprising:
a composite price generator configured to generate a composite price for the currency pair based on the pricing information received from the first and the second liquidity providers.

18. The system of claim 17, wherein the composite price generator is further configured to:
evaluate the currency pair pricing information received from the first and second liquidity providers to identify a best seller and a best buyer from a perspective of the customer; and
route the foreign exchange transaction to at least one of the best seller and the best buyer.

19. The system of claim 18, wherein:
the receiver is further configured to repeat receiving of currency pair price information for a plurality of liquidity providers; and
the composite price generator is further configured to generating of a composite price for the currency pair based on the pricing information received from the plurality of liquidity providers.

20. The system of claim 16, wherein the currency pair pricing information includes a plurality of currency pairs.

21. The system of claim 16, wherein the currency pair pricing information includes a bid price and the step of determining is performed using the bid price.

22. The system of claim 21, wherein the trading platform charges the customer a commission based on an amount of the foreign exchange transaction.

23. The system of claim 16, wherein the currency pair pricing information includes an ask price and the step of determining is performed using the ask price.

24. The system of claim 23, wherein the trading platform charges the customer a commission based on an amount of the foreign exchange transaction.

25. The system of claim 16, wherein the receiver is further configured to receive at least one of a bid price and ask price from another customer related to the currency pair; and the system further comprises:
a composite price generator configured to generate a composite price for the currency pair based on the pricing information received from the first liquidity provider and the at least one bid price and ask price from the another customer.

26. The system of claim 16, wherein the receiver is further configured to receive from the customer a transaction request for an asset other than a foreign exchange transaction; and the system further comprises:
a non-currency exchange platform configured to perform the transaction request.

27. The system of claim 26, wherein the transaction request relates to buying or selling one or more equity instruments.

28. The system of claim 27, further comprising an account manager configured to:
manage an account for the customer such that the one or more equity instruments are valued according to a base currency selected by the customer.

29. The system of claim 28, wherein all assets within the account are valued according to the base currency.

30. The system of claim 28, wherein the base currency is changeable by the customer without liquidating an assets within the account.

31. A computer readable medium bearing executable instruction for performing a foreign exchange transaction between a trading platform and a customer, the instruction upon execution cause one or more processors to perform the steps of:
receiving, by the trading platform, currency pair pricing information from a first liquidity provider;
receiving the foreign exchange transaction from the customer;
determining whether the foreign exchange transaction can be executed; and
responsive to the determining, placing the foreign exchange transaction on an internal order book.
